(19) United States
(12) Patent Application Publication
(10) Pub. No.: US 2009/0041897 A1
(43) Pub. Date: Feb. 12, 2009

(54) Transparent, concentrated liquid nutritional supplement composition

(76) Inventor: Aly Gamay, McLean, VA (US)

Correspondence Address: ALY GAMAY, 1102 Mill Ridge, McLean, VA, 22102, US

(21) Appl. No.: 11/889,086

(22) Filed: Aug. 9, 2007

(51) Int. Cl. A23L 1/29; A23L 1/0522; A23L 1/0532; A23L 1/302; B65D 85/00; A23L 1/0562; A23L 1/236

(52) U.S. Cl. 426/61; 426/115; 426/548; 426/575; 426/576; 426/578; 426/648; 426/71; 426/72

(57) ABSTRACT

Disclosed is a composition of liquid nutritional supplement and nutritional components in a concentrated form. The composition includes sweeteners, nutritional supplements, flavors, colors, thickening agents, acidifying agents or combinations thereof in a shelf stable format. The composition also describes making a portable lightweight liquid nutritional supplement mix or nutritional supplement. Additionally, the composition includes providing clear and non-turbid liquid nutritional supplement upon dilution in dilution media.

### FIELD OF INVENTION

The present invention relates to composition of pre-measured, transparent, shelf-stable liquid nutritional supplement concentrate that is readily miscible with any liquid medium without turbidity, precipitation or mechanical action for incorporation, producing clear, non-turbid liquid nutritional supplement without visible sign of ingredients precipitation.

### BACKGROUND

Commercially available vitamin and mineral supplements are useful in many circumstances where improved nutrient intake is desirable. Nutritional supplements usually sold as pills, capsules, powders and effervescent tablets. However, adhering to a daily routine of nutritional supplementation has had limited success because it is difficult for the consumer to ingest numerous pills and capsules on a daily basis especially if the size of the nutritional supplement is large and packed with nutrients.

Functional liquids containing supplements are becoming mainstream due to ease of consumption and compliance.

Some liquid nutritional supplements are fortified with vitamins or minerals. Many nutritional supplements contain herbals like Echinacea, Guarana, Ginkgo Biloba, or Kava that supposedly help energize, calm, or promote well-being in other ways.

Functional beverages containing vitamins and minerals have recently been launched by many companies. PepsiCo launched a line of fruit-flavored, vitamin-mineral enhanced waters. Coca-Cola produced bottled water with added minerals.

According to Information Resources, while sales of carbonated beverages, such as soda, have dropped about 4 percent in the last five years, sales of bottled water have more than tripled, because people have become more health conscious.

Companies rolled out a barrage of lightly sweetened “waters” laced with fruit flavors, vitamins, herbs and even ingredients used to treat specific medical conditions.

There are other enriched and functional waters on the market that come in ready to drink large plastic or glass bottles and cans. They are often sold in large packs of 6 to 24 units. In addition to being extremely heavy to carry as packs, they are not easily portable to workplace or for travel. It will be desirable to have the same enriching and functional ingredients in concentrated forms that are portable and light to carry to be added to any water upon consumption. Additionally, empty cans and bottles overload our recycling systems and represent challenges to available recycling technology. It will be suitable to have enriching and functional ingredients in concentrated forms in small packages that does not take large space and easily recyclable. Moreover, it will be environmentally-friendly to deliver high concentrations of various rejuvenating-nutrients or refreshing ingredients in relatively small volume reduce the cost of energy needed for transportation, thus reducing pollution.

Knowing the health merits of water, consumers can be encouraged to take nutritional supplements by offering nutritionally superior flavored, and enhanced waters. Studies suggest that this may often be true, flavored water helps individuals consume nutritional supplement in an easy and regular fashion.

The nutritional supplement industry has responded to compliance problems due to having to ingest numerous large pills (as in the case of joint care supplements) by offering liquid nutritional supplements to be ingested directly using kitchen utensils such as spoons. However, these liquids are difficult to pour precisely into a spoon due to spilling over and may also cause loss of active and nutritious components resulting in a deficiency of dose taken. Moreover, because the liquid supplement is usually loaded with ingredients (to deliver enough nutrients in one to two table spoons), the taste of the liquid supplement is usually unacceptable and derive potential consumers away.

A variety of powdered dry nutritional supplement blends have been offered. However, these powders are difficult to pour precisely to a bottle of water without spilling on bottleneck and edges and dusting the air with powder particles and losing some of the powder which may also cause loss of active and nutritious components resulting in a deficiency of dose taken.

Furthermore, one of the shortcomings of powdered nutritional supplement mixes is that they require vigorous shaking to incorporate the powdered mix. Because vigorous mechanical action is required, it may be troublesome for some consumers to ensure incorporating all dry materials into bottled water or any other liquid.

Another problem with dry mixes is that they usually leave an un-dissolved layer of powder at the bottom of bottled water, which is visually repulsive.

Another disadvantage of dry nutritional supplement mixes is that it does not produce clear and transparent liquid nutritional supplement due to the use of maltodextrin and other filling materials as carriers for flavors and blending media of all ingredients.

Flavored water, because it is a clear product just like water, is more closely linked to water's heritage and is more appealing to health conscious consumers. However, when dry mixes are used to produce functional flavored water or functional nutritional supplements, they produce cloudy and turbid liquid nutritional supplements that are not as appealing.

It will be very desirable to offer concentrated nutritional supplement liquids that are transparent and clear resembling the actual bottled flavored water and functional water. Furthermore, it would be technologically advantageous to develop concentrated liquids of liquid nutritional supplement blends and nutritionally superior compositions that are easy to use and incorporate into containers of liquids without loss of product or vigorous mechanical action to dissolve and solubilize ingredients and/or nutrients.

### SUMMARY

The present invention relates to compositions of pre-measured, transparent, shelf-stable liquid nutritional supplement concentrates that are readily miscible and mixable with any liquid medium without turbidity, precipitation or mechanical action for incorporation, producing clear liquid nutritional supplement without visible sign of ingredients precipitation.

The composition teaches procedures of screening and selecting water soluble constituents, combining water and water soluble constituents to form transparent liquid nutritional supplement concentrate, adjusting pH of transparent liquid nutritional supplement concentrate to about 3.5 or lower, dispensing the transparent liquid nutritional supplement concentrate into pre-formed containers and hermetically sealing the pre-formed containers.

The present invention describes making a composition for delivering liquid nutritional supplement and nutritional components in a concentrated form. The composition includes providing sweeteners, nutritional supplements, flavors, colors, thickening agents, acidifying agents or combinations thereof, and mixtures thereof in a preservative free and shelf stable format. The composition also is suitable to provide portable lightweight liquid nutritional supplement mix or nutritional supplement. Additionally, the composition includes providing clear and non-turbid liquid nutritional supplement upon dilution in dilution medium like water.

A further embodiment of the present invention includes a composition for delivering a pre-measured, transparent, shelf-stable liquid nutritional supplement concentrate that is readily miscible with any liquid medium without shaking or agitation and without creating cloudiness or turbidity after dilution. Furthermore, the diluted concentrate will show no visible sign of ingredients precipitation.

The composition comprises adding selected water soluble constituents, combining water and water soluble constituents to form transparent liquid nutritional supplement concentrate, adjusting pH of transparent liquid nutritional supplement concentrate to about 3.5 or lower, dispensing the acidified transparent liquid nutritional supplement concentrate into pre-formed container, hermetically sealing the pre-formed container, and dispensing acidified transparent liquid nutritional supplement concentrate from the pre-formed container into a dilution medium for ingestion. Additionally a preservative may be included in the composition.

A further embodiment includes a portable kit comprising a preformed package, and a pre-measured, shelf-stable nutritional concentrate consists essentially of liquid; and a water soluble additive selected from the group consisting of sweeteners, nutritional supplements, flavors, colors, thickening agents or combinations thereof, wherein the performed package allows for packaging and portability of the pre-measured, shelf-stable liquid nutritional supplement concentrate, and allows for easy dispensing into containers of fluids as well as protection of dissolved water soluble nutrients. The kit contains water-soluble constituents selected to provide a transparent and non-turbid solution without cloudiness or precipitation The kit further comprises between about 30% to about 90% water. The portable kit may also include transparent liquid nutritional supplement filled into said pre-formed container at amounts about 5 to 30 ml.

### DETAILED DESCRIPTION

The present invention describes a composition for delivering a pre-measured, transparent, preservative-free, shelf-stable liquid nutritional supplement concentrate that is readily miscible with any liquid medium without shaking or agitation and without creating cloudiness or turbidity after dilution. Furthermore, the diluted concentrate will show no visible sign of ingredients precipitation.

The composition includes selecting water soluble constituents, combining water and water soluble constituents to form transparent liquid nutritional supplement concentrate, adjusting pH of transparent liquid nutritional supplement concentrate to about 3.5 or lower, dispensing the acidified transparent liquid nutritional supplement concentrate into pre-formed container, hermetically sealing the pre-formed container, and dispensing acidified transparent liquid nutritional supplement concentrate from the pre-formed container into a dilution medium for ingestion.

The composition of the present invention includes delivering liquid nutritional supplement and nutritional components in a concentrated form. The composition includes providing sweeteners, nutritional supplements, flavors, colors, thickening agents, acidifying agents or combinations thereof and mixtures thereof in a preservative free and shelf stable format. The composition also includes providing portable lightweight liquid nutritional supplement mix or nutritional supplement. Additionally, the composition includes providing clear and non-turbid liquid nutritional supplement upon dilution in dilution media.

All liquid nutritional supplement concentrates are able to benefit from the compositions of the invention. The compositions are effective for obtaining clear and transparent diluted liquid nutritional supplements that are appealing to consumers.

The components of the composition are in a form that is systemically soluble or miscible with water. The components can be pre-hydrated or pre-solubilized either individually or in various combinations for enhanced dispersion. After being dissolved, the components of the composition, or their byproducts, are delivered to the pre-formed package without the need for preservatives.

The present concentrated nutrient fortified liquid products may be produced in various combinations to provide preparations that could be mixed with water or other fluids, to provide liquid nutritional drink or liquid nutritional supplements. Because the ingredients are pre-hydrated in water before consumption, the preparation mixes with water instantly without vigorous agitation. The resultant finished product shows no visible signs of cloudiness or turbidity and pleasant to use immediately. In an embodiment, further it essentially comprises sufficient amounts of colors, flavors, acids and active ingredients to produce a variety of nutritional liquids with vast appearances, functionality and health benefits.

The pre-measured amount of concentrated liquids in the pre-formed units essentially delivers various components and/or nutrients at required ratios in hydrated status available for fast and enhanced absorption in the human body. The pre-formed packages and its structure maintains the present nutrients and actives in a hydrated status, ready for addition to dilution media for immediate ingestion without the need for re-measuring or mechanical action to impact the solubilization of nutrients. Clear and transparent pre-formed packages may add visual appeal to finished liquids.

The small volume dispensed into each kit further allows for lightweight units that realize significant savings in shipping and delivering the products to consumers.

Packing high concentrations of various rejuvenating-nutrients in relatively small volume reduce the cost of energy needed for transportation, thus reducing the pollution and helping the environment.

Packing high concentrations of various rejuvenating-nutrients or healthy ingredients in relatively small volume to be added to a glass of water should reduce the cost of energy needed for disposing off and recycling the empty packages compared to the cost needed for disposing off and recycling the empty aluminum cans and plastic bottles of ready to drink vitamin waters thus reducing the pollution and helping the environment. Because only 10-20 grams of the liquid concentrates are used to produce equivalent of 480 to 2000 grams of comparable ready to drink nutritional supplement, using the concentrated liquids in the current invention will reduce the shipping weight of ready to nutritional supplement liquid nutritional supplement by 97 to 99%. From environmentally and economically perspectives, it is advantageous to utilize the current invention to produce quality liquid nutritional supplements and help the environment.

Providing composition for making light weight, high impact liquids that are shelf stable, easy to carry, pre-measured and easy to mix with fluids to provide appealing liquid nutritional supplement and/or health promoting nutritional supplements involves several steps in selecting ingredients, processing the components and final packaging to ensure the safety and integrity of finished products.

### Sweeteners

Suitable materials for use as nutritive carbohydrate sweetening agents are well known in the art. Examples of sweetening agents include both monosaccharide and disaccharide sugars such as sucrose, invert sugar, dextrose, lactose, honey, maltose, fructose, maple syrup and corn syrup or corn syrup solids. Example nutritive carbohydrate sweetening agents include those selected from the group consisting of sucrose, glucose, fructose, and corn syrup solids.

Non-sugar nutritive sweeteners may be utilized. Examples of non-sugar nutritive sweeteners include mannitol, sorbitol, maltitol, xylitol, lactitol monohydrate, erythritol, and glycerin.

Suitable non-nutritive sweeteners may also be used for sugar-free functional foods. Example of non-nutritive sweeteners includes Sucralose, Aspartame, Saccharin, Acesulfame Potassium and other high potency sweeteners. Of course, mixtures of the above-noted materials are contemplated herein.

### Flavors

Optionally, the present concentrated liquids products can further additionally include effective amounts of flavor(s). If present, such flavors can comprise effective amounts of flavors to provide desired flavor levels. Generally, flavors present at from about 0.01% to about 5% of the finished products are contemplated.

### Thickening Agent

The thickening agent may be used at lower concentration to produce a desired consistency of liquid concentrate to accommodate specific ingredients. Good results are obtained when all or at least a portion of the thickening agent is supplied by a member from the group consisting of collagen (gelatin), gellan gum, carbohydrate gel forming polymers (such as pectin, gel forming starches, agar, and mixtures thereof), carrageenan, Carbo bean, gum, locust bean gum and alginates. Other thickening agents may include but not be limited to guar, Xanthan, gums, Carboxymethyl cellulose and thickening clear starch. Generally, good results are obtained when the total thickening agent is present at levels ranging from about 0.05% to 2.0%.

### Nutritional Additives:

Any of the water dissolvable nutritional supplements may be used in formulating the composition of the present composition. If nutritional additives are not water soluble, a form of water soluble or miscible version may be employed as long as it does not separate or precipitate in either the pre-formed package or the final diluted product.

Nutritional supplements maybe selected from groups consisting of water soluble vitamins, water miscible vitamins, antioxidants, minerals, herbal extracts, liquid extracts of herbs, water soluble fiber, prebiotics, probiotics, joint care nutrients, gelatin, collagen, amino acids, brain stimulating nutrients, water soluble pharmaceutical compounds, water soluble nutraceutical compounds, performance enhancers and combinations thereof.

Vitamins are very popular in liquid format. Vitamins are divided into two categories based on water solubility. Fat soluble vitamins, i.e. A, D, E, K and water soluble i.e. B and C. When powdered dry mix is formulated, various vitamins may be used because it will be added to water and consumed instantly. However, liquid formulations require special attention to suspend the vitamins as well as preserve the potency during shelf life. If fat soluble vitamin such as E is required in the formulation, a water miscible version has to be employed, such as Vitamin E Acetate. Vitamin A Palmitate and Beta-Carotene may be acceptable forms of Vitamin A.

Vitamin C is water soluble, however it degrades in water in fast fashion, therefore, proper temperature at addition is to be observed. Furthermore, Vitamin C functions as an acidifying agent and may be used between 0.05 and 20.0%.

Among joint and skin rejuvenating nutrients, Collagen, Glucosamine, Chondroitin and MSM are very popular. Collagens (and it is denatured form gelatin) are a family of highly characteristic fibrous proteins found in all multicellular animals and may serve as a gelling agent. They are the most abundant proteins in mammals, constituting 25% of their total protein. The central feature of all collagen molecules is their stiff, triple-stranded helical structure. Three collagen polypeptide chains, called alpha-chains, are wound around each other in a regular helix to generate a rope-like collagen molecule about 300 nm long and 1.5 nm in diameter. At most, eleven genetically distinct collagen types have been well defined. The major types are referred to as types I, II, III, IV and V. Types I, II and III are the main types of collagen found in connective tissues, and of these, type I is the most common, constituting about 75% of the collagen in the body. After being secreted into the extracellular space, types I, II and III collagen molecules assemble into ordered polymers called collagen fibrils, which are long (up to many microns), thin (10 to 300 nm in diameter), cable-like structures clearly visible in electron micrographs. Such fibrils are often grouped into larger bundles, which can be seen in the light microscope as collagen fibers several microns in diameter.

Collagen is the main constituent of the supporting tissue and connective tissue in animals and humans and, more particularly, is found in the skin, the tendons and bones. Collagen may be produced from animal skin, animal bones and other sufficiently purified connective tissue. Hydrolyzed Collagen is readily water soluble while Gelatin which is a denatured collagen is soluble only in hot water and upon cooling is capable of binding considerable amounts of water.

Glucosamine, which is naturally found in high concentrations in joint structures, is a stable, tasteless and water-soluble nutrient. It is readily absorbed from the intestines, stays in the blood for several hours, and very little is excreted. In particular, glucosamine stimulates the body's manufacture of collagen, the protein portion of the fibrous substance that holds joints together.

Chondroitin sulfate is the major glycosaminoglycan in cartilage and may have a synergistic effect with Glucosamine and is soluble in water. MSM (Methyl-Sulfonyl-Methane) is also known as dimethyl sulfone or sulfonylbismethan is readily water soluble.

An example joint care and/or skin and nail composition may include D-Glucosamine HCL (99%) added at 200 to 2000 mg, Chondroitin Sulfate (90%) added at 100 to 2000 mg, MSM (99%) added at 100 to 2000 mg, commercial gelatin may be added at 0.5-22% and hydrolyzed Collagen which is available from commercial sources may be added at 0.5 to 10%.

Minerals may be also included in the composition. Water soluble mineral such as sodium and potassium may be used to induce a sports nutritional supplement. Whilst, calcium and magnesium are not soluble and may not be used in this invention because they induce cloudiness and turbidity in both concentrate and finished liquid nutritional supplement. Furthermore, they increase the pH of the concentrate to high levels (up to pH 8.0) which negatively impact the shelf stability of the preservative free, acidified composition.

Energy boosting ingredients may be utilized in the current invention. Taurine, Inositol, Caffeine and herbal extracts are examples. To maintain the clarity of the liquid concentrate as well as the finished diluted liquid nutritional supplement/supplement, liquid extracts of herbal preparations may be used. Filtration of liquid preparation is essential to eliminate any particulates or suspended materials.

### Acidulant

Sufficient amounts of an edible organic acid or acidulant are added to produce a pH of about 3.5, or about 0.5 to 4.0. The particular pH selected from within this pH range depends in part upon a preservative being employed as well as the organoleptic attributes desired. A variety of edible organic acids can be used to adjust the pH of the present invention as well as to control the taste and tartness of the present products. For example, citric acid, tartaric acid, malic acid, ascorbic acid, lactic acid, phosphoric acid, hydrochloric acid and mixtures thereof may be used.

Acidulant further provide optimum pH for extended shelf life of functional foods without refrigeration. Furthermore, acidulants enhance flavor perception to affect various flavor profiles.

The acidulant modify the product's pH to a range of about 0.5 to 3.5, which is desirable for extending the shelf life of the concentrate as well as provide good tasting finished liquid nutritional supplement.

### Additional Ingredients

The present food compositions can optionally contain a variety of additional ingredients suitable for rendering such products more organoleptically acceptable, more nutritious and/or more storage stable. Such optional components include fiber materials, colors (natural colors, artificial colors, fruit derived colors, vegetable derived colors, insect derived colors like Carmine), preservatives (selected from the group consisting of nisin, sorbic acid or a salt of, benzoic acid or a salt of, EDTA, Methyl Paraben, Propyl Paraben, natural preservatives, synthetic preservatives or mixtures thereof and emulsifiers.

According to Wikipedia, Turbidity is a cloudiness or haziness of water (or other fluid) caused by individual particles (suspended solids) that are generally invisible to the naked eye. Measurement of turbidity is a key test of water quality. Fluids can contain suspended solid matter consisting of particles of many different sizes. While some suspended material will be large enough and heavy enough to settle rapidly to the bottom container if a liquid sample is left to stand (the settleable solids), very small particles will settle only very slowly or not at all if the sample is regularly agitated or the particles are colloidal. These small solid particles cause the liquid to appear turbid. It should be noticed that it is an objective of the current invention to produce clear and non turbid liquids.

A property of the particles, that they will scatter a light beam focused on them, is utilized in Nephelometer with the detector setup to the side of the light beam. More light reaches the detector if there are lots of small particles scattering the source beam than if there are few. The units of turbidity from a calibrated Nephelometer are called Nephelometric Turbidity Units (NTU). To some extent, how much light reflects for a given amount of particulates is dependent upon properties of the particles like their shape, color, and reflectivity. For this reason (and the reason that heavier particles settle quickly and do not contribute to a turbidity reading).

A turbidity standards of 5 NTU the liquid is considered clear, at 50 NTU is considered hazy, while at 500 NTU is considered cloudy.

Solubility refers to the ability for a given substance, the solute, to dissolve in a solvent. It is measured in terms of the maximum amount of solute dissolved in a solvent at equilibrium. The resulting solution is called a saturated solution. Certain substances are soluble in all proportions with a given solvent, such as ethanol in water. This property is known as miscibility.

Under various conditions, the equilibrium solubility can be exceeded to give a so-called supersaturated solution, which is metastable. The solvent is often a liquid, which can be a pure substance or a mixture.

The term insoluble is often applied to poorly soluble compounds, though strictly speaking there are very few cases where there is absolutely no material dissolved. The solubility of one substance dissolving in another is determined by the balance of intermolecular forces between the solvent and solute and the entropy change that accompanies the solvation. Factors such as temperature and pressure will alter this balance, thus changing the solubility.

Solubility may also strongly depend on the presence of other species dissolved in the solvent.

Dissolution is not always an instantaneous process. It is fast when salt and sugar dissolve in water but much slower for a tablet aspirin or a large crystal of hydrated copper sulfate. The speed at which a solid dissolves in a liquid may depend on its crystalline properties and the presence of polymorphism.

In the embodiment of the current invention, each ingredient is screened for solubility in water and for producing transparent liquid without any turbidity or observed opaqueness. Each ingredient or nutrient is evaluated at suitable concentration (based on actual usage level) in 100 ml deionized water enclosed in glass bottle and checked for turbidity. Only non turbidity producing materials (estimated at 25 NTU or less) were selected. Visual evaluation also conducted to ensure clear liquids are obtained. Solutions with an estimated 30 NTG and above are eliminated as potential ingredients. Bottles were also checked for precipitated solids at 0, 2, 4, 6, 8, 10 and 24 hours at room temperature. If precipitate is observed, the ingredient/nutrient is rendered unusable for producing appealing liquid nutritional supplement. Furthermore, ingredients are evaluated in a final diluted liquid nutritional supplement and/or diluents to ensure that dilution will not change the physical appearance of concentrates.

Solubility in water is a key factor in determining ingredients/nutrients to employ in the current invention. Insoluble materials are excluded from the formulation. Saturation point is also observed for each ingredient/nutrient to ensure that no precipitation will occur. Solutions of ingredients/nutrients were tested at temperature of 95, 104, 120 and 140° F. for extended periods of time (up to 60 days) to screen for cloudiness and precipitation.

As an additional screening step, simple filtration process using lab filter Grade 313, Fluted Circles, Folded, Qualitative filters are utilized. Fluid under it is own gravity is filtered to observe any collected solids. Solids collected on the lab filter indicate that precipitation will occur in both the concentrated liquid as well as the finished liquid nutritional supplement.

As an additional screening step, simple observation composition was utilized. Final diluted water containing the exact amount of a concentrated liquid is filled into a 500 ml clear plastic Solo cup that has a brand embossed clearly at the bottom. About 200 grams of the diluted final liquid is filled into the abovementioned cup. The cub is then placed on a black sheet. Looking from the top of cup, if the embossed brand (Solo) on the bottom of cup can be seen and read clearly, then the composition is acceptable. When compared to other diluted powdered dry mixes, the brand name could not be seen in the case of diluents prepared using other dry mixes.

A final evaluation of the clarity and transparency of final diluted water nutritional supplement, 10 grams of uncolored version of the liquid concentrate is prepared, added to 500 grams of deionized water, then visually compared to deionized water in clear glass containers. Only clarity and transparency producing ingredients/nutritional supplements were selected for the invention.

In one of the embodiments, selected ingredients-nutrients are added to the rest of ingredients and water in a processor and heat treated to 165° F. to dissolve all ingredients and affect pasteurization of the liquid.

To aid in full solubilization and hydration of desirable selected ingredients-nutrients, a pre-hydrating step maybe employed by pre-hydrating either individual selected ingredient-nutrient or combination thereof. Water may be heated to 110° F.-170° F., and then selected ingredients-nutrients are added slowly with agitation to ensure complete hydration and solubilization. The pre-hydration step may be accomplished over about 10-50 minutes until no visible undissolved particle is observed.

Any of food processing vessels may be used to combine and heat-treat the ingredients.

Any sequence of ingredients addition may be adopted. In one embodiment, water is added first to the processor, then selected ingredients-nutrients are added, then acidifying agents are added, then pasteurization of liquid is performed at 160° F.-190° F. Concentrated liquids are then suitable for further filling into suitable containers.

Various filling temperatures between about 100° F.-170° F. may be employed without impacting the product integrity, except in case of heat sensitive vitamins or ingredients (i.e. Vitamin C) they are added after cooling the concentrated liquid to about 110-130° F. Cooling of the finished product is optional.

The transparent liquid concentrate maybe additionally dispensed into pre-formed or thermoformed containers or packages and hermetically sealed for extended shelf life. The film material for the pre-formed container is selected from the group consisting of PVC, PVDC, HIPS, PS, PE or Poly Propylene. These resins maybe thermoformed and filled employing equipment such as Unifill Unit.

It is preferable to utilize a clear film and resin to package the liquids of the current inventions in order to accomplish appealing appearance. Transparent film such as PVC or PVDC materials, when thermoformed into blisters, provide a non-opaque barrier that is may reflect the clarity and transparency of the concentrated liquids. That may present a marketing merit.

Fill volume may vary. Between about 5 and 30 ml of liquid concentrates are usually sufficient to deliver required composition. Pre-measuring ensure delivering the required amounts of ingredients and supplements. Furthermore, pre-measurement present a convenience feature not obtained when using bulk powder mix or liquid supplements in a large bottles.

The concentrates produced according to the present invention may be handled and distributed either at room temperature, refrigerated or frozen.

To consume the final product of the current invention, the pre-formed, pre-measured concentrated liquids, the package is opened and liquid poured into bottled water, glass of water, any liquid nutritional supplement (hot or cold) and treats. The liquid mixed easily with any fluid without vigorous agitation.

### EXAMPLES

To evaluate the precipitation and solubility of available components, ingredients, and nutrients, a study was initiated. Deionized water was heated to 98° F.-99° F. Adjustment of pH of the water to 2.7-2.9 was accomplished using citric acid. Each ingredient is screened for solubility in water and for producing transparent liquid without any turbidity or observed opaqueness. Each ingredient or nutrient is evaluated at suitable concentration (based on actual usage level) in 100 ml deionized water enclosed in glass bottle and checked turbidity. Only non turbid producing materials (estimated at 25 NTU or less) were selected. Visual evaluation also conducted to ensure clear liquids are obtained. Solutions with an estimated 30 NTU and above are eliminated as potential ingredients.

Bottles were also checked for precipitated solids at 0, 2, 4, 6, 8, 10 and 24 hours. If precipitate is observed, the ingredient/nutrient is rendered unusable for producing appealing liquid nutritional supplement. Furthermore, ingredients are evaluated in a final diluted liquid nutritional supplement to ensure that dilution will not change the physical appearance of concentrates.

Since solubility in water is a key factor in determining ingredients/nutrients to be employed in the current invention. Insoluble materials are excluded from the formulation. Saturation point is also observed for each ingredient/nutrient to ensure that no precipitation will occur. Solutions of ingredients/nutrients were tested at temperature of 95, 104, 120 and 140 for extended periods of time to screen for cloudiness and precipitation.

As additional screening step, simple filtration process using lab filter and fluid under it is own gravity of is used to observe any collected solids. Solids collected on the lab filter indicate that precipitation will occur in both the concentrated liquid as well as the finished liquid nutritional supplement.

### Example 1

Pre-measured, transparent, preservative-free, shelf-stable, sugar free liquid nutritional supplement concentrates were produced according to the teachings of the present invention. A transparent, preservative-free, shelf-stable liquid nutritional supplement concentrate that is readily miscible with any liquid medium without shaking or agitation was produced by: Screening and selecting water soluble constituents as in the current example, adding water to the water soluble constituents to form transparent liquid, adjusting pH of transparent liquid nutritional supplement concentrate to about 1.0 to 2.8, dispensing 10 ml of the acidified transparent liquid nutritional supplement concentrate into pre-formed container; hermetically sealing the pre-formed container.

The concentrated liquids were formulated as follows:

| Ingredient | A | B | C | D |
|---|---|---|---|---|
| Citric Acid | 8.75 | 8.50 | 6 | 6 |
| Ascorbic Acid | 9.00 | 7.00 | 5 | 5 |
| Sucralose | 0.700 | | 0.7 | |
| Acesulfame Potassium | | | | 0.2 |
| Aspartame | | | | 1.5 |
| Xanthan Gum | 0.05 | | 0.1 | |
| Flavors | 2.00 | 3.00 | 2 | 1.5 |
| Vitamin B Blend (25% or RDA) | 0.25 | 0.25 | | |
| Red #40 | 0.20 | | | 0.3 |
| Fruit Juice Concentrate | | 4 | | |
| Naturally Derived Color | | | 1.5 | |
| Potassium Citrate | 0.25 | 0.25 | 0.5 | |
| Water | 78.80 | 77.00 | 84.20 | 85.50 |
| TOTAL | 100.00 | 100.00 | 100.00 | 100.00 |

After dispensing the transparent liquid nutritional supplement concentrate from the pre-formed container into 470 ml water, visual tests were conducted to confirm the transparency of the finished liquid nutritional supplement by examining the finished liquid nutritional supplement. All compositions provided clear non turbid nutritional supplement liquids. Furthermore, organoleptic evaluation was conducted to determine the acceptability of final liquid nutritional supplements. All formulations were comparable or better in taste to other powdered dry mix blends on the market. However, the current formulations provided superior incorporation into liquids as well as clarity. Other dry preparation available commercially produced liquid nutritional supplements ranging from cloudy to non transparent liquids. Some dry blends caused visual precipitation at the bottom of nutritional supplementing containers. That appearance was perceived to be unacceptable. The actual pH readings ranged between about 1.1 and 3.0.

### Example 2

Pre-measured, transparent, preservative-free, shelf-stable, refreshing, sugar free, ultra-concentrated liquid nutritional supplement concentrates were produced according to the teachings of the present invention. A transparent, preservative-free, shelf-stable liquid nutritional supplement concentrate that is readily miscible with any liquid medium without shaking or agitation was produced by: Screening and selecting water soluble constituents as in the current example, adding water to the water soluble constituents to form transparent liquid, adjusting pH of transparent liquid nutritional supplement concentrate to about 0.5-1.0, dispensing 10 ml of the acidified transparent liquid nutritional supplement concentrate into pre-formed container; hermetically sealing the pre-formed container.

The ultra-concentrated nutritional liquids were formulated as follows:

| Ingredient | A | B | C |
|---|---|---|---|
| Citric Acid | 35 | 30 | 35 |
| Ascorbic Acid | | 4 | 3 |
| Vitamin B Blend (25% or RDA) | 1.00 | 1.00 | |
| Sucralose | | 2 | |
| Acesulfame Potassium | 2 | 2.2 | 2 |
| Aspartame | 5 | 5 | 5 |
| Xanthan Gum | | 0.05 | |
| Flavors | 10 | 15 | 5 |
| Red #40 | 1 | 1 | |
| Fruit Juice Concentrate | | | 30 |
| Naturally Derived Color | | 4 | |
| Potassium Citrate | | 1 | |
| Water | 46.00 | 34.75 | 20.00 |
| TOTAL | 100.00 | 100.00 | 100.00 |

After dispensing the acidified transparent liquid nutritional supplement concentrate from the pre-formed container into 2000 grams water, visual tests were conducted to confirm the transparency of the finished liquid nutritional supplement by examining the finished liquid nutritional supplement. All compositions provided clear non turbid nutritional supplement liquids. Furthermore, organoleptic evaluation was conducted to determine the acceptability of final liquid nutritional supplements. All formulations were comparable in taste to other powdered dry mix blends on the market. However, the current formulations provided superior incorporation into liquids as well as clarity. Other dry preparation available commercially produced liquid nutritional supplements ranging from cloudy to non transparent liquids. Some dry blends caused visual precipitation at the bottom of nutritional supplementing containers and that was perceived to be unacceptable. The actual pH readings ranged between about 0.4 and 1.3.

### Example 3

To formula A in example 1, antioxidant blend of Vitamin A, Vitamin C (Beta Carotene) and Vitamin E (Acetate) was added to the liquid product at about 100° F.-130° F., and then the product was packaged. The amount of vitamins was balanced to obtain about 25% of recommended daily allowance of these vitamins.

### Example 4

To formula A in example 1, antioxidant blend of Vitamin A, Vitamin C (Palmitate), Vitamin E (Acetate) and natural antioxidant blend composed of: green tea extract, Blueberry extract, CoQ10, was added to the liquid product at about 100° F.-130° F., and then the product was packaged. The amount of vitamins was balanced to obtain about 25% of recommended daily allowance of vitamins.

### Example 5

To formula A in example 1, additional blend of Vitamin B1, B2, B3, B5, B12, Folate, was added to the liquid product at about 160° F.-170° F., and then the product was packaged. The amount of vitamins was balanced to obtain about 100% of recommended daily allowance of these vitamins.

### Example 6

Pre-measured, transparent, preservative-free, shelf-stable, sugar containing, liquid mineral-containing nutritional supplement concentrates were produced according to the teachings of the present invention. A transparent, preservative-free, shelf-stable mineral-containing liquid nutritional supplement concentrate that is readily mixable with any liquid medium without shaking or agitation was produced by: Screening and selecting water soluble constituents as in the current example, adding water to the water soluble constituents to form transparent liquid, adjusting pH of transparent liquid nutritional supplement concentrate to about 1.5, dispensing 10 ml of the acidified transparent liquid nutritional supplement concentrate into pre-formed container; hermetically sealing the pre-formed container.

The concentrated liquids were formulated as follows:

| Ingredient | A | B | C |
|---|---|---|---|
| Citric Acid | 7.00 | 8.50 | 6 |
| Ascorbic Acid | | | 1 |
| Sucralose | 0.700 | | 1 |
| Acesulfame Potassium | | 0.1 | |
| Aspartame | | 0.8 | |
| Xanthan Gum | 0.05 | | 0.1 |
| Flavors | 2.00 | 3.00 | 6 |
| Yellow #5 | 0.005 | | |
| Dextrose | 25.000 | 20.00 | 10 |
| Glucosamine | | 4 | |
| Naturally Derived Color | | | 3 |
| Salt | 6 | 8 | 8 |
| Potassium Citrate | 3 | 2 | 0.5 |
| Water | 56.25 | 53.60 | 64.40 |

After dispensing the acidified transparent liquid mineral-containing nutritional supplement concentrate from the pre-formed container into 470 ml water, visual tests were conducted to confirm the transparency of the finished liquid nutritional supplement by examining the finished liquid nutritional supplement. All compositions provided clear non turbid nutritional mineral-containing liquids. Furthermore, organoleptic evaluation was conducted to determine the acceptability of final liquid nutritional supplements by a group of food scientists. All formulations had acceptable taste. The mineral-containing nutritional supplement contained various amounts of sodium and potassium electrolyte minerals as well a source of carbohydrate in addition to joint rejuvenating Glucosamine.

### Example 7

Varieties of Joint-care, skin, hair and nail nutritional supplement compositions were developed. Pre-measured, transparent, preservative-free, shelf-stable, refreshing, sugar free liquid nutritional concentrates were produced according to the teachings of the present invention. A transparent, preservative-free, shelf-stable liquid nutritional concentrate that is readily miscible with any liquid medium without shaking or agitation was produced by: Screening and selecting water soluble constituents as in the current example, adding water to the water soluble constituents to form transparent liquid, adjusting pH of transparent liquid nutritional supplement concentrate to about 2.5-3.5, dispensing 10 to 25 ml of the acidified transparent liquid nutritional concentrate into pre-formed container; hermetically sealing the pre-formed container.

The concentrated liquids were formulated as follows:

| Ingredient | A | B | C | D |
|---|---|---|---|---|
| Citric Acid | 3.00 | 5.00 | 3 | 4 |
| Ascorbic Acid | 1.00 | | 1 | |
| Sucralose | 0.700 | | 1 | 0.5 |
| Flavors | 2.00 | 2.00 | 2 | 2 |
| Red #40 | 0.200 | 0.10 | 0.2 | 0.1 |
| Glucosamine | 13.000 | 13.00 | 13 | 13 |
| Chondroitin Sulfate | | 10 | | |
| MSM | | 5 | | |
| Hydrolyzed Collagen | | | 25 | 45 |
| Water | 80.10 | 64.90 | 54.80 | 35.40 |
| TOTAL | 100.00 | 100.00 | 100.00 | 100.00 |

After dispensing the acidified transparent liquid nutritional supplement concentrate from the pre-formed container into 250 ml water or apple juice, visual tests were conducted to confirm the transparency of the finished nutritional. All compositions provided clear non turbid nutritional liquids. Furthermore, organoleptic evaluation was conducted to determine the acceptability of final nutritional liquids. Formula D in this example delivered unprecedented amount of hydrolyzed collagen (about 10,000 mg) in a liquid form when used at about 22 ml per serving. Taste was deemed to be excellent.

### Example 8

Same ingredients in example 7 were utilized, except 0.1% of each of sorbic acid and benzoic acid were added to make a preservative containing nutritional supplement concentrate.

### Example 9

A kit containing liquid nutritional herbal supplement compositions were developed. A pre-formed, pre-measured kit composing of transparent, preservative containing, shelf-stable, refreshing, sugar free liquid nutritional concentrates were produced according to the teachings of the present invention to provide preparations for energy boosting and immune system enhancement. A transparent, preservative-containing, shelf-stable liquid nutritional concentrate that is readily miscible with any liquid medium without shaking or agitation was produced by: Screening and selecting water soluble constituents as in the current example, adding water to the water soluble constituents to form transparent liquid, adjusting pH of transparent liquid nutritional supplement concentrate to about 3.0-5.5, dispensing 5 to 30 ml of the acidified transparent liquid nutritional concentrate into pre-formed container; hermetically sealing the pre-formed container.

The concentrated liquids were formulated as follows:

| Ingredient | A | B | C | D |
|---|---|---|---|---|
| Malic Acid | | 4.00 | 2 | 2 |
| Taurine | 10.00 | 5.00 | | 5 |
| Inositol | 0.500 | | | 0.5 |
| Caffeine | 1.00 | | 1 | 1 |
| Liquid Ginseng Extract | 2.000 | | | 1 |
| liquid Green Tea Extract | 2.000 | | 5 | 1 |
| Liquid Echinacea Extract | | | | 1 |
| Water | 84.50 | 91.00 | 92.00 | 88.50 |
| TOTAL | 100.00 | 100.00 | 100.00 | 100.00 |

After dispensing the transparent liquid concentrate from the pre-formed container into 500 ml water, visual tests were conducted to confirm the transparency of the finished nutritional. All compositions provided clear non turbid nutritional supplement liquids. The pH of preservative containing liquids ranged between 2.8 and 5.7.

### Example 10

A kit containing liquid nutritional herbal supplement compositions were developed. A pre-formed, pre-measured kit composing of transparent, preservative free, shelf-stable, refreshing, sugar free liquid nutritional concentrates were produced according to the teachings of the present invention to provide preparations for energy boosting and immune system enhancement. A low water activity, flavorless, transparent, preservative-containing, shelf-stable liquid nutritional concentrate that is readily miscible with any liquid medium without shaking or agitation was produced by: Screening and selecting water soluble constituents as in the current example, adding water to the water soluble constituents to form transparent liquid, adjusting pH of transparent liquid nutritional supplement concentrate to about 3.0-4.5, dispensing 5 to 30 ml of the acidified transparent liquid nutritional concentrate into pre-formed container; hermetically sealing the pre-formed container.

The concentrated liquids were formulated as follows:

| Ingredient | A | B | C | D |
|---|---|---|---|---|
| Malic Acid | | 4.00 | 2 | 2 |
| Taurine | 10.00 | 5.00 | | 5 |
| Inositol | 0.500 | | | 0.5 |
| Caffeine | 1.00 | | 1 | 1 |
| Liquid Ginseng Extract | 2.000 | | | 1 |
| liquid Green Tea Extract | 2.000 | | 5 | 1 |
| Liquid Echinacea Extract | | | | 1 |
| Glycerin | 20.000 | 40.00 | | 15 |
| Sorbitol | | 0.1 | 30 | 15 |
| Water | 64.50 | 50.90 | 62.00 | 58.50 |
| TOTAL | 100.00 | 100.00 | 100.00 | 100.00 |

Because the concentrated liquid supplement is flavorless, it could be added to any liquid without imparting flavor to the final preparation. After dispensing the transparent liquid concentrate from the pre-formed container into 280 ml orange juice, brewed tea, milk shake, nectar liquid nutritional supplement visual tests were conducted to confirm the transparency of the concentrated nutritional liquids. Water activity ranged between 0.75 and 0.9 in the concentrated liquids before addition to diluents.

What is claimed is:

1. A composition of transparent, preservative-free, shelf-stable liquid nutritional supplement concentrate that is readily miscible with any liquid medium without shaking or agitation comprising:
Water; and
water soluble, non-turbid additive selected from the group consisting of sweeteners, nutritional supplements, flavors, colors, thickening agents, acidifying agents or combinations thereof.

2. The composition of claim 1, wherein the water soluble, non-turbid additive is selected to provide a transparent and non-turbid solution without cloudiness or precipitation.

3. The composition of claim 1, wherein the liquid nutritional supplement concentrate further comprises between about 30% to about 90% water.

4. The composition of claim 1, wherein the liquid nutritional supplement concentrate is packaged in pre-formed container selected from the group consisting of PVC, PVDC, HIPS, PS, PE or Poly Propylene or combinations thereof.

5. The composition of claim 1, wherein the liquid nutritional supplement concentrate is filled into pre-formed container at amounts about 5 to 30 ml.

6. The composition of claim 1, wherein the liquid nutritional supplement concentrate has a pH between about 0.5 to about 2.5.

7. The composition of claim 1, wherein the sweeteners are selected from the group selected consisting of monosaccharides, disaccharides, sucralose, aspartame, saccharin, Acesulfame Potassium, include mannitol, sorbitol, maltitol, xylitol, lactitol monohydrate, erythritol, and glycerin, and combinations thereof.

8. The composition of claim 1, wherein the nutritional supplements are selected from the group consisting of water soluble vitamins, water miscible vitamins, antioxidants, minerals, herbal extracts, liquid extracts of herbs, water soluble fiber, prebiotics, probiotics, joint care nutrients, gelatin, collagen, amino acids, brain stimulating nutrients, water soluble pharmaceutical compounds, water soluble nutraceutical compounds, performance enhancers and combinations thereof.

9. The composition of claim 1, wherein the flavors are selected from the group consisting of sweet, savory, herbal flavors and combinations thereof.

10. The composition of claim 1, wherein the colors are selected from the group consisting of natural colors, artificial colors, fruit derived colors, vegetable derived colors, insect derived colors and combinations thereof.

11. The composition of claim 1, wherein the thickening agent is selected from the group consisting of collagen, gellan gum, carbohydrate gel forming polymers, Carbo bean gum, locust bean gum, carrageenan, alginates, guar, xanthan, carboxymethyl cellulose, clear starch and mixtures thereof.

12. The composition of claim 1, wherein the acidifying agent is selected from the group consisting of citric acid, tartaric acid, malic acid, ascorbic acid, lactic acid, phosphoric acid, hydrochloric acid and combinations thereof.

13. The composition of claim 1, wherein the liquid nutritional supplement concentrate is an energy supplement concentrate.

14. The composition of claim 1, wherein the liquid nutritional supplement concentrate is a mineral-containing nutritional supplement concentrate.

15. A composition of non-turbid, shelf-stable liquid nutritional supplement concentrate that is readily miscible with any liquid medium without shaking or agitation comprising:
Water; and
water soluble, non-turbid additive selected from the group consisting of sweeteners, nutritional supplements, flavors, colors, thickening agents, acidifying agents, preservatives or combinations thereof.

16. The composition of claim 15, wherein the water soluble, non-turbid additive is selected to provide a transparent and non-turbid solution without cloudiness or precipitation.

17. The composition of claim 15, wherein the liquid nutritional supplement concentrate further comprises between about 30% to about 90% water.

18. The composition of claim 15, wherein the liquid nutritional supplement concentrate is packaged in pre-formed container selected from the group consisting of PVC, PVDC, HIPS, PS, PE or Poly Propylene or combinations thereof.

19. The composition of claim 15, wherein the liquid nutritional supplement concentrate is filled into pre-formed container at amounts about 5 to 30 ml.

20. The composition of claim 15, wherein the liquid nutritional supplement concentrate has a pH between about 3.5 to about 5.5.

21. The composition of claim 15, wherein the sweeteners are selected from the group selected consisting of monosaccharides, disaccharides, sucralose, aspartame, saccharin, Acesulfame Potassium, include mannitol, sorbitol, maltitol, xylitol, lactitol monohydrate, erythritol, and glycerin, and combinations thereof.

22. The composition of claim 15, wherein the nutritional supplements are selected from the group consisting of water soluble vitamins, water miscible vitamins, antioxidants, minerals, herbal extracts, liquid extracts of herbs, water soluble fiber, prebiotic, probiotic, joint care nutrients, gelatin, collagen, amino acids, brain stimulating nutrients, water soluble pharmaceutical compounds, water soluble nutraceutical compounds, performance enhancers and combinations thereof.

23. The composition of claim 15, wherein the flavors are selected from the group consisting of sweet, savory, herbal flavors and combinations thereof.

24. The composition of claim 15, wherein the colors are selected from the group consisting of natural colors, artificial colors, fruit derived colors, vegetable derived colors, insect derived colors and combinations thereof.

25. The composition of claim 15, wherein the thickening agent is selected from the group consisting of collagen, gellan gum, carbohydrate gel forming polymers, Carbo bean gum, locust bean gum, carrageenan, alginates, guar, xanthan, carboxyniethyl cellulose, clear starch and mixtures thereof.

26. The composition of claim 15, wherein the acidifying agent is selected from the group consisting of citric acid, tartaric acid, malic acid, ascorbic acid, lactic acid, phosphoric acid, hydrochloric acid and combinations thereof.

27. The composition of claim 15, wherein the liquid nutritional supplement concentrate is an energy supplement concentrate.

28. The composition of claim 15, wherein the liquid nutritional supplement concentrate is a mineral-containing nutritional supplement concentrate.

29. The composition of claim 15, wherein the preservative is selected from the group consisting of nisin, sorbic acid or a salt of, benzoic acid or a salt of, EDTA, Methyl Paraben, Propyl Paraben, natural preservatives, synthetic preservatives or mixtures thereof.

30. A portable kit comprising
a preformed package, and
a pre-measured, shelf-stable nutritional supplement concentrate consists essentially of water; and
a non-turbid water soluble additive selected from the group consisting of sweeteners, nutritional supplements, flavors, colors, thickening agents, preservatives or combinations thereof,
wherein the performed package allows for packaging and portability of the pre-measured, shelf-stable liquid nutritional supplement concentrate, and allows for easy dispensing into containers of fluids as well as protection of dissolved water soluble additives.

31. The kit of claim 30, wherein the non-turbid water soluble additive is selected to provide a transparent and non-turbid solution without cloudiness or precipitation.

32. The kit of claim 30, wherein the shelf-stable nutritional supplement concentrate further comprises between about 30% to about 90% water.

33. The kit of claim 30, wherein the pre-formed container is selected from the group consisting of clear and transparent PVC or PVDC combinations thereof.

34. The kit of claim 30, wherein the said shelf-stable nutritional supplement concentrate is filled into said pre-formed container at amounts about 5 to 30 ml.

35. The kit of claim 30, wherein acidified transparent liquid nutritional supplement concentrate has a pH between about 0.5 to about 5.5.

36. The kit of claim 30, wherein the sweeteners are selected from the group selected consisting of monosaccharides, disaccharides, sucralose, aspartame, saccharin, Acesulfame Potassium, include mannitol, sorbitol, maltitol, xylitol, lactitol monohydrate, erythritol, and glycerin, and combinations thereof.

37. The kit of claim 30, wherein the nutritional supplements are selected from the group consisting of water soluble vitamins, water miscible vitamins, antioxidants, minerals, herbal extracts, liquid extracts of herbs, water soluble fiber, prebiotics, probiotics, joint care nutrients, gelatin, collagen, amino acids, brain stimulating nutrients, water soluble pharmaceutical compounds, water soluble nutraceutical compounds, performance enhancers and combinations thereof.

38. The composition of claim 30, wherein the flavors are selected from the group consisting of sweet, savory, herbal flavors and combinations thereof.

39. The kit of claim 30, wherein the colors are selected from the group consisting of natural colors, artificial colors, fruit derived colors, vegetable derived colors, insect derived colors and combinations thereof.

40. The kit of claim 30, wherein the thickening agent is selected from the group consisting of collagen, gellan gum, carbohydrate gel forming polymers, Carbo bean gum, locust bean gum, carrageenan, alginates, guar, xanthan, carboxymethyl cellulose, clear starch and mixtures thereof.

41. The kit of claim 30, wherein the acidifying agent is selected from the group consisting of citric acid, tartaric acid, malic acid, ascorbic acid, lactic acid, phosphoric acid, hydrochloric acid and combinations thereof.

42. The kit of claim 30, wherein the pre-measured, transparent, shelf-stable liquid nutritional supplement concentrate is an energy supplement concentrate.

43. The kit of claim 30, wherein the pre-measured, transparent, shelf-stable liquid nutritional supplement concentrate is a sports nutritional supplement concentrate.

44. The kit of claim 30, wherein the preservative is selected from the group consisting of nisin, sorbic acid or a salt of, benzoic acid or a salt of, EDTA, Methyl Paraben, Propyl Paraben, natural preservatives, synthetic preservatives or mixtures thereof.

45. The kit of claim 30, wherein the preformed package is hermetically sealed.
